(19) United States
(12) Patent Application Publication
(10) Pub. No.: US 2008/0028426 A1
(43) Pub. Date: Jan. 31, 2008

(54) Video/Audio Stream Processing Device and Video/Audio Stream Processing Method

(76) Inventors: Osamu Goto, Osaka (JP); Toru Inada, Kyoto (JP); Akira Kitamura, Osaka (JP)

Correspondence Address: MCDERMOTT WILL & EMERY LLP, 600 13TH STREET, NW, WASHINGTON, DC, 20005-3096, US

(21) Appl. No.: 11/630,337

(22) PCT Filed: Jun. 20, 2005
(86) PCT No.: PCT/JP05/11256

§ 371 Date: Dec. 21, 2006

(30) Foreign Application Priority Data
Jun. 28, 2004 (JP) 2004-190376

(51) Int. Cl. G06F 3/00

(52) U.S. Cl. 725/39

(57) ABSTRACT

Video/audio data is stored in an HDD (115) and information concerning to the video/audio data is also generated and stored with the video/audio data. A comparison unit (112) compares the video/audio data with feature data stored in a selector unit (111) and detects a position where the feature data is contained. When the feature data is detected, a tag information generation unit (113) generates tag information and stores the tag information after adding thereto the video/audio data.

### TECHNICAL FIELD

The present invention relates to video/audio stream processing devices, and more particularly to a video/audio stream processing device and a video/audio stream processing method for storing video/audio data after adding thereto information concerning the video/audio data.

### BACKGROUND ART

Currently, Electric Program Guides (EPGs) are provided using airwaves, and detailed contents information (program information) is provided from websites via a communication line such as the Internet or the like. Viewers can use the Electric Program Guide and the detailed contents information, etc., to obtain information concerning, for example, the start/finish time of each program and program details.

In recent years, a video/audio stream processing device (hereinafter, referred to as the “AV stream processing device”) that stores program data after adding thereto detailed contents information concerning the program in order to facilitate searching for recorded programs is proposed (e.g., Patent Document 1).

FIG. 23 is a block diagram of a conventional AV stream processing device 1. The AV stream processing device 1 includes a digital tuner 2, an analog tuner 3, an MPEG2 encoder 4, a host CPU 5, a modem 6, a hard disk drive (HDD) 8, an MPEG2 decoder 9, a graphic generation unit 10, a synthesizer 11, a memory 12 and a user panel 13.

For example, a video/audio signal of a broadcast program provided from a broadcasting company by digital broadcasting is received by an unillustrated antenna and inputted to the digital tuner 2. The digital tuner 2 processes the inputted video/audio signal and outputs an MPEG2 transport stream (hereinafter, referred to as the “MPEG2TS”) of the program.

Also, a video/audio signal of a broadcast program provided from a broadcasting company by analog broadcasting is received by an unillustrated antenna and inputted to the analog tuner 3. The analog tuner 3 processes the inputted video/audio signal and outputs the processed video/audio signal to the MPEG2 encoder 4. The MPEG2 encoder 4 outputs the inputted video/audio signal after encoding it to MPEG2 format. The MPEG2TSs of the digital broadcast program and the analog broadcast program, which are outputted from the digital tuner 2 and the MPEG2 encoder 4, are stored in the HDD 8.

As such, in parallel with or after storing the MEPG2TSs of the broadcast programs in the HDD 8, the AV stream processing device 1 downloads detailed contents information via the Internet and records it into the HDD 8 in association with the stored MPEG2TSs of the broadcast programs.

Based on an instruction signal outputted from the host CPU 5 in accordance with an input to the user panel 13, the graphic generation unit 10 generates a program information screen based on the detailed contents information stored in the HDD 8. The generated program information screen is displayed on an unillustrated display unit, and therefore the user can appreciate program details by viewing the screen. In addition, the AV stream processing device 1 can play back an AV data stream from the position of each topic indicated by the detailed contents information.

Therefore, by using the AV stream processing device 1, it is possible to efficiently search for a program containing a topic that is desired to be viewed among recorded broadcast programs In addition, the AV stream processing device 1 obviates troublesome searching for the position where the topic that is desired to be viewed is recorded through repetitive operations such as fast-forwarding, playing back and rewinding.

[Patent Document 1] Japanese Laid-Open Patent Publication No. 2003-199013

### DISCLOSURE OF THE INVENTION

### Problems to be Solved by the Invention

However, the AV stream processing device 1 is not able to add and record detailed contents information with video/audio data having no detailed contents information, e.g., video/audio data recorded in a videotape or video/audio data of personally captured moving images. Therefore, video/audio data having no detailed contents information cannot be the subject of a search.

In addition, even video/audio data having detailed contents information does not always contain information required for appreciating the details or conducting a search because information provided by the detailed contents information is limited.

Therefore, an object of the present invention is to provide an AV stream processing device capable of individually generating information that can be used for searching in relation to video/audio data having no detailed contents information or the like.

### Solution to the Problems

A first aspect of the present invention is directed to a video/audio stream processing device for storing video/audio data after adding thereto information concerning the video/audio data, including: a feature data holding unit for storing feature data concerning video/audio or characters; a feature data detection unit for detecting a position where the feature data is contained in the video/audio data; a tag information generation unit for generating tag information when the feature data is detected in the feature data detection unit; and a video/audio data storage unit for storing the video/audio data and the tag information.

Also, according to a preferred embodiment, a timer for measuring time at the detected position on the video/audio data is further included, and the tag information contains time information based on the time measured by the timer.

Also, according to another preferred embodiment, a specific data extraction unit for extracting specific data, which is used for detection in the feature data detection unit, from a plurality of types of data included in the video/audio data, and outputting the specific data to the feature data detection unit is further included.

Also, a data format conversion unit for converting the video/audio data into digital data in a predetermined format, and outputting the digital data to the specific data extraction unit is further included, and the data format conversion unit may include: an analog data conversion unit for converting analog data into digital data in a predetermined format; and a digital data conversion unit for converting digital data in a format other than the predetermined format into digital data in the predetermined format.

Also, according to yet another preferred embodiment, the tag information contains identifier data indicating which feature data has been used for detection.

Also, according to yet another preferred embodiment, a graphic generation unit for generating a screen which allows a user to select a playback position by using the tag information is further included, and displays the detected position as a candidate for the playback position.

Also, according to yet another preferred embodiment, a keyword search information generation unit for generating keyword search information by using character data added to the video/audio data is included.

Note that a video data extraction unit for extracting video data in a specific region of the video/audio data where subtitles are contained and a subtitles recognition unit for converting into character data subtitles contained in the video data extracted by the video data extraction unit are further included, and the keyword search information generation unit may use the character data obtained by the video recognition unit to generate the keyword search information.

Also, an audio data extraction unit for extracting audio data from the video/audio data and a speech recognition unit for converting the audio data extracted by the audio data extraction unit into character data are further included, and the keyword search information generation unit may use the character data obtained by the speech recognition unit to generate the keyword search information.

Also, according to yet another preferred embodiment, a keyword input unit for inputting characters which are desired to be searched for and a keyword search unit for searching the keyword search information for the characters inputted from the keyword input unit are further included.

A second aspect of the present invention is directed to a video/audio stream processing method for storing video/audio data after adding thereto information concerning the video/audio data, including: storing the video/audio data and detecting a position where predetermined feature data concerning video/audio or characters is contained in the video/audio data; generating tag information when the detecting has been performed; and storing the video/audio data after adding the tag information thereto.

According to a preferred embodiment, measuring time at the detected position on the video/audio data is further included, and the tag information may contain time information based on the specified time.

Also, according to another preferred embodiment, before performing the detecting, extracting data for use in the detecting from a plurality of types of data included in the video/audio data is further included.

Note that when the video/audio data is analog data or digital data in a format other than a predetermined format, converting the video/audio data into digital data in the predetermined format before extracting the data for use in the detecting is further included.

Also, according to another preferred embodiment, the tag information contains identifier data indicating which feature data has been used for the detecting.

Also, according to another preferred embodiment, generating a screen which allows a user to select a playback position by using the tag information, and displays the detected position as a candidate for the playback position is further included.

Also, according to another preferred embodiment, obtaining character data added to the video/audio data; and generating keyword search information by using the obtained character data are further included.

Note that the character data may be obtained by extracting video data in a specific region of the video/audio data where subtitles are contained, and converting into character data subtitles contained in the extracted video data.

Also, the character data may be obtained by extracting audio data from the video/audio data, and converting the extracted audio data into character data.

Also, according to another preferred embodiment, generating the keyword search information for each section defined by the detected position; searching the keyword search information for characters inputted by a user; and generating a screen for displaying a search result for each section are further included.

### EFFECT OF THE INVENTION

An AV stream processing device according to the present invention detects a characteristic portion designated by the user from video/audio data that is to be recorded, and individually generates search information based on the search result. Thus, the user is able to readily find a desired position from the video/audio data by using the generated search information.

Also, an AV stream processing device according to the present invention is capable of generating keyword search information based on character data obtained from an AV stream that is to be stored. Thus, the user is able to readily find a position in the AV stream that is suitable for viewing by searching the keyword search information for a keyword representing a portion that is desired to be viewed by characters.

### BRIEF DESCRIPTION OF THE DRAWINGS

FIG. 1 is a block diagram of an AV stream processing device according to a first embodiment of the present invention.

FIG. 2 is a diagram for explaining data stored in an AV feature value holding unit and a selector unit.

FIG. 3 is a diagram for explaining processes in a comparison unit.

FIG. 4 is a flow chart illustrating the procedure for generating an information file.

FIG. 5 is a diagram illustrating an exemplary segment table.

FIG. 6 is a diagram illustrating an exemplary tag information file.

FIG. 7 is a diagram continued from FIG. 6.

FIG. 8 is a diagram illustrating data stored in an HDD.

FIG. 9 is a diagram illustrating an example of a screen generated based on a tag information file.

FIG. 10 is a flowchart illustrating a process of playing back AV data.

FIG. 11 is a block diagram of an AV stream processing device according to a second embodiment of the present invention.

FIG. 12 is a diagram for explaining a DVD VR format.

FIG. 13 is a diagram showing a timing chart at the time of generating a keyword search file.

FIG. 14 is a flow chart illustrating the procedure for generating a keyword search file.

FIG. 15 is a diagram illustrating an exemplary segment table.

FIG. 16 is a diagram illustrating an exemplary tag information file.

FIG. 17 is a diagram continued from FIG. 16.

FIG. 18 is a diagram illustrating an example of a search result display screen generated based on an information file and a keyword search file.

FIG. 19 is a flow chart for explaining the procedure for a search process.

FIG. 20 is a diagram illustrating features used for a search process.

FIG. 21 is a block diagram of an AV stream processing device according to a third embodiment of the present invention.

FIG. 22 is a block diagram of an AV stream processing device according to a fourth embodiment of the present invention.

FIG. 23 is a block diagram of a conventional AV stream processing device.

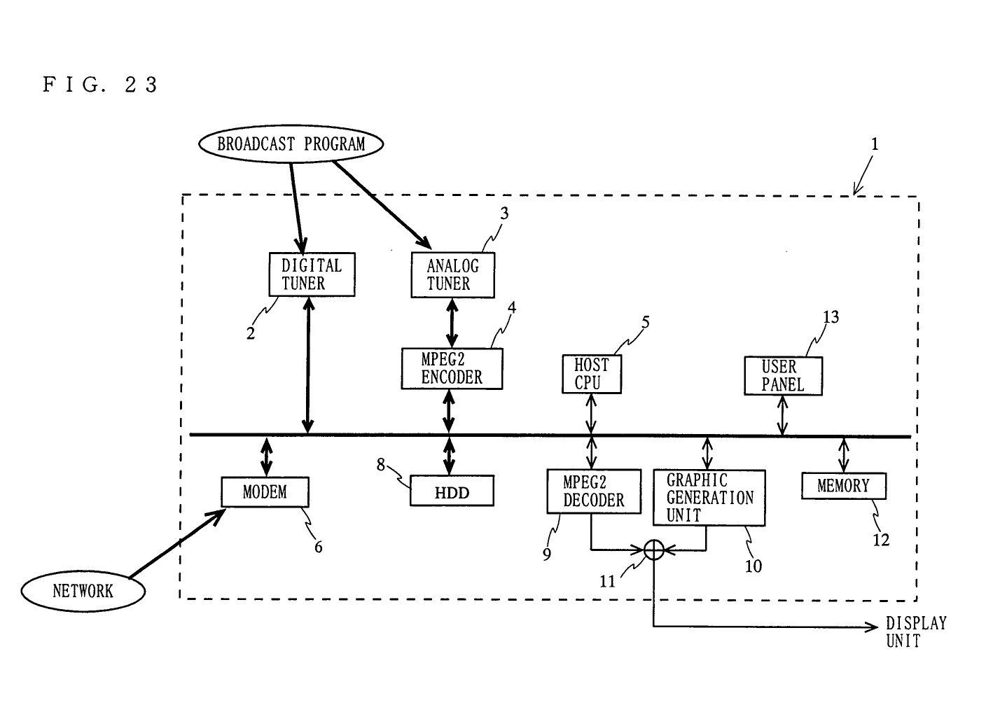

### DESCRIPTION OF THE REFERENCE CHARACTERS

100 AV stream processing device
101 digital tuner
102 analog tuner
103 switching unit
104 format conversion unit
105 decode processing unit
106 A/D conversion unit
107 splitter unit
108 MPEG encoder
110 AV feature value holding unit
111 selector unit
112 comparison unit
113 tag information generation unit
114 host CPU
115 HDD
116 memory
117 MPEG decoder
118 graphic generation unit
119 synthesizer
120 user panel
200 AV stream processing device
201 character data accumulation unit
202 character string search unit
251 search keyword holding unit
252 search comparator
253 search match number counter
300 AV stream processing device
301 speech recognition unit
400 AV stream processing device
401 subtitles recognition unit

### BEST MODE FOR CARRYING OUT THE INVENTION

### First Embodiment

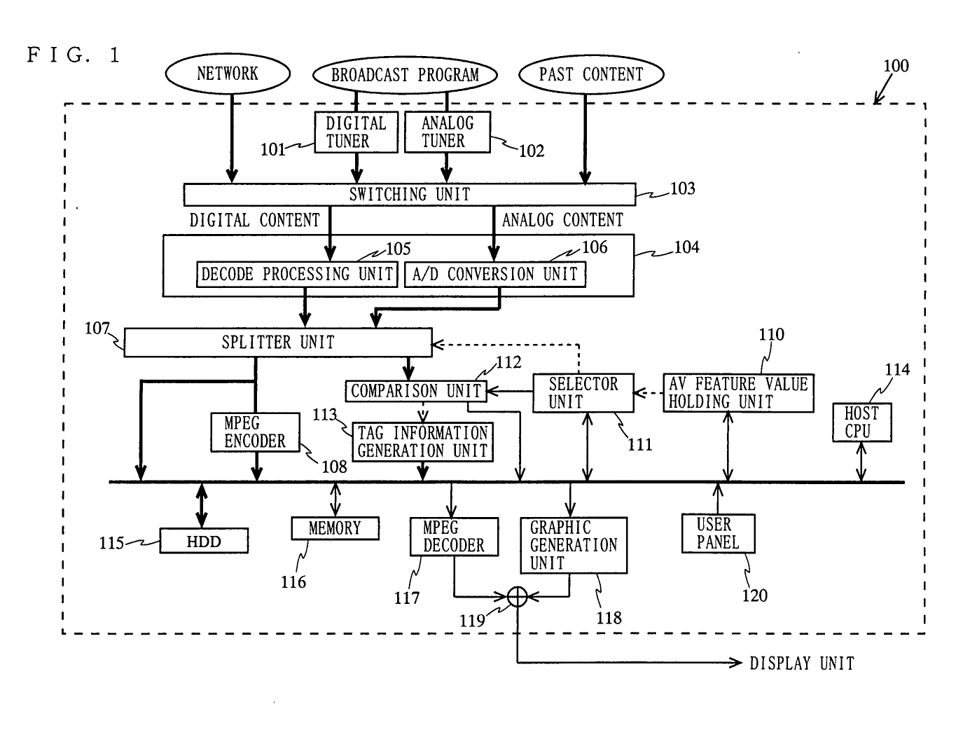

FIG. 1 is a block diagram illustrating the configuration of an AV stream processing device 100 according to a first embodiment of the present invention. The AV stream processing device 100 includes a digital tuner 101, an analog tuner 102, a switching unit 103, a format conversion unit 104, a splitter unit 107, an MPEG encoder 108, an AV feature value holding unit 110, a selector unit 111, a comparison unit 112, a tag information generation unit 113, a host CPU 114, a hard disk drive (hereinafter “HDD”) 115, a memory 116, an MPEG decoder 117, a graphic generation unit 118, a synthesizer 119 and a user panel 120.

The user panel 120 is a panel includes buttons, a remote controller, a keyboard or the like provided on the body of the AV stream processing device 100, which allows the user to operate the AV stream processing device 100. The host CPU 114 is an arithmetic processing unit for generally controlling each unit included in the AV stream processing device 100.

The digital tuner 101 processes, for example, a video/audio signal of a digital broadcast program received by an unillustrated antenna, and outputs an MPEG2 transport stream (MPEG2TS) of the program. In addition, the analog tuner 102 processes a video/audio signal of an analog broadcast program received at an antenna, and outputs an analog video/audio signal of the program.

The switching unit 103 receives video/audio data of a program that is to be stored to the HDD 115 via the digital tuner 101, the analog tuner 102 or the Internet. In addition, the switching unit 103 utilizes the USB or IEEE1394 standards to receive video/audio data accumulated in externally connected devices such as a DVD device, an LD device, an external HDD and a VHS video device. Accordingly, the switching unit 103 receives analog video/audio data, uncompressed digital video/audio data and compressed digital video/audio data. Thus, the AV stream processing device 100 is capable of handling video/audio data of any type or format. In the present descriptions, the analog video/audio data, the uncompressed digital video/audio data and the compressed digital video/audio data are collectively referred to herein as video/audio data (hereinafter “AV data”).

The switching unit 103 has a role of distributing inputted AV data to a suitable destination depending on its type. To describe it more concretely, analog AV data inputted to the switching unit 103 is inputted to the A/D conversion unit 106 in the format conversion unit 104. The A/D conversion unit 106 converts the analog AV data to uncompressed digital AV data in a given format. Also, digital AV data inputted to the switching unit 103 is inputted to the decode processing unit 105 in the format conversion unit 104. The decode processing unit 105 determines the format of the inputted data and, if necessary, performs a process of decoding to a given format.

As such, the format conversion unit 104 receives AV data of various types or formats, and AV data in a predetermined given format. Note that audio and video data outputted from the format conversion unit 104 may be provided as separate data, for example, such that the audio data is PCM data and the video data is REC656 data, or as in MPEG-format data typified by MPEG2PS (MPEG2 program stream), the two data types may be provided as one data set. However, data outputted from the format conversion unit 104 and data stored in the selector unit 111, which will be described later, are required to be uniform in format so that they can be compared in the comparison unit 112.

The AV data outputted from the format conversion unit 104 is inputted to the splitter unit 107. The splitter unit 107 includes a recording data output port for outputting all inputted AV data and a tag information generation data output port for outputting only specific data extracted for generating an information file.

In the case where AV data outputted from the recording data output port of the splitter unit 107 is MPEG-format data, the AV data is directly stored to the HDD 115. On the other hand, in the case where AV data outputted from the recording data output port of the splitter unit 107 is not MPEG-format data, the AV data is inputted to the MPEG encoder 108. The MPEG encoder 108 outputs the inputted AV data after encoding it to MPEG format, for example. The MPEG outputted from the MPEG encoder 108 is stored to the HDD 115.

The specific data outputted from the tag information generation data output port of the splitter unit 107 is data used for detecting a characteristic portion of video/audio data, and its type is decided depending on data stored in the selector unit 111.

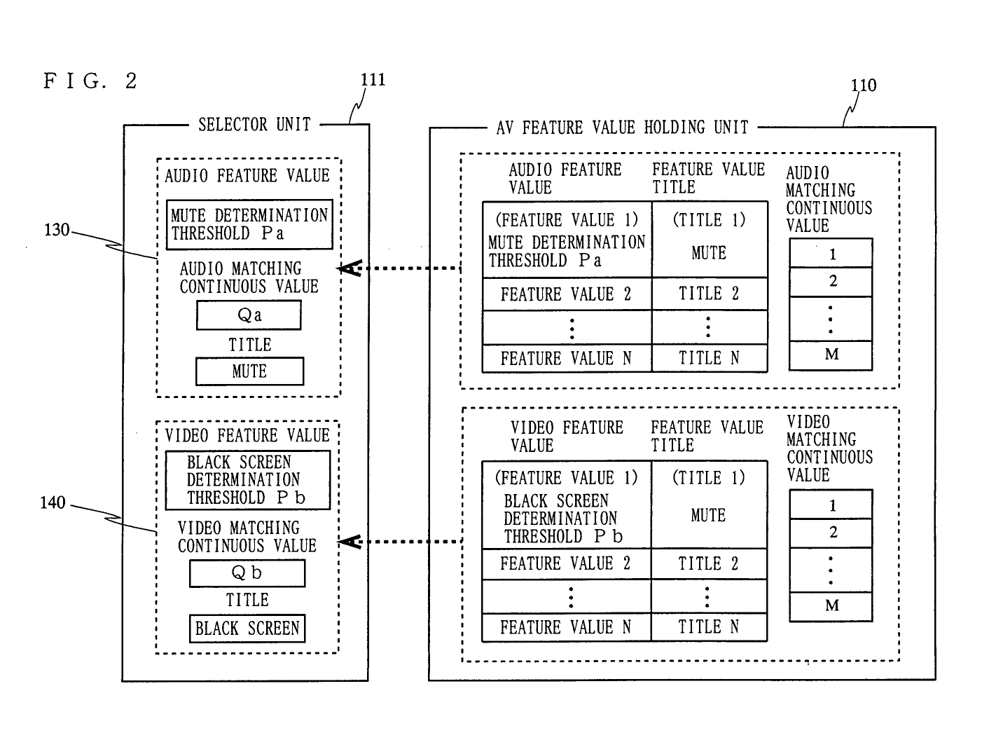

FIG. 2 is a diagram illustrating exemplary data stored in the selector unit 111 and the AV feature value holding unit 110. The AV feature value holding unit 110 stores therein candidates for data used for detecting a characteristic portion of video/audio data that is to be recorded. For example, the AV feature value holding unit 110 has stored therein a plurality of audio feature value data pieces, feature value title data and audio matching continuous value data for each of the audio feature value data pieces, a plurality of video feature value data pieces, and feature value title data and video matching continuous value data for each of the video feature value data pieces. The feature value title data is identifier data added to each of the feature value data pieces for allowing the user to identify which feature value data piece has been used for detection.

The graphic generation unit 118 generates a screen showing, for example, what feature value data is stored in the AV feature value holding unit 110. The screen generated by the graphic generation unit 118 is displayed on a display unit such as a TV screen or a monitor of a personal computer. Therefore, before recording, the user views the screen and uses the user panel 120 to select desired feature value data and matching continuous value data. The selected feature value data, feature value title data and matching continuous value data are stored in the selector unit 111. A series of processes, which includes reading data stored in the AV feature value holding unit 110 and writing data to the selector unit 111, are controlled by the host CPU 114. The feature value data that is to be stored in the AV feature value holding unit 110 may be previously generated and stored by the manufacturer of the AV stream processing device 100 or may be generated and stored by the user.

FIG. 2 shows a case where the selector unit 111 selects audio data and video data from the AV feature value holding unit 110. The selected audio feature value data in the selector unit 111 shown in FIG. 2 is a mute determination threshold Pa titled “MUTE”. An audio matching continuous value is Qa. In addition, video feature value data is a black screen determination value threshold Pb titled “BLACK SCREEN”. A video matching continuous value is Qb. Pa represents sound volume and Pb represents brightness. In addition, Qa and Qb represent a time period. In the case where audio feature value data and video feature value data are selected by the selector unit 111 as shown in FIG. 2, uncompressed audio data (e.g., PCM data) and video data (e.g., REC656 data) are outputted from the splitter unit 107 to the comparison unit 112.

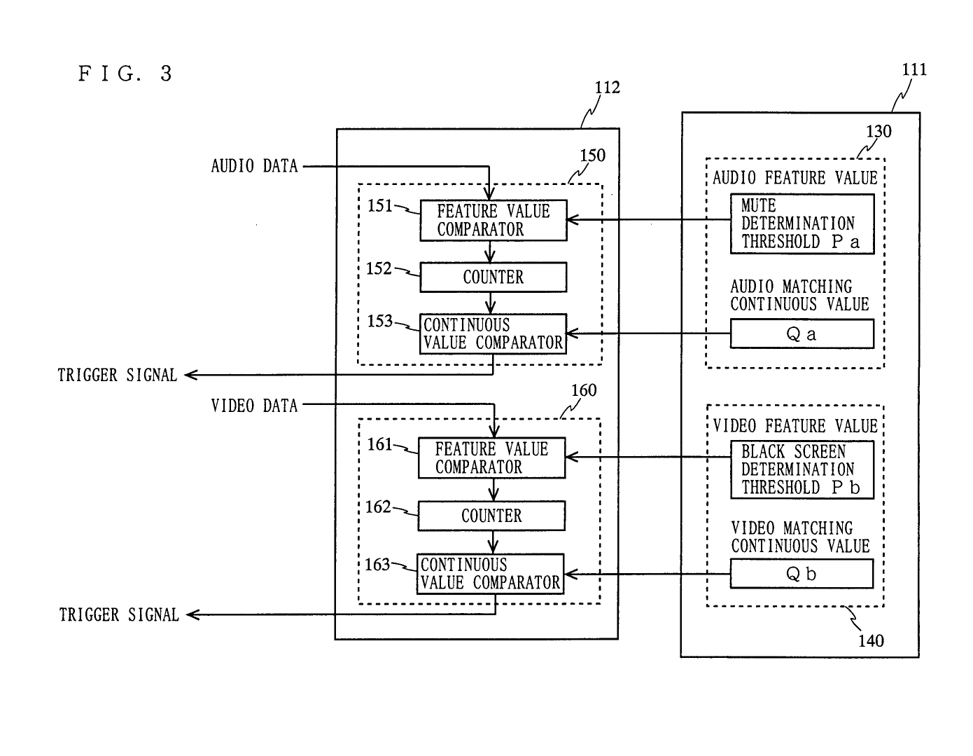

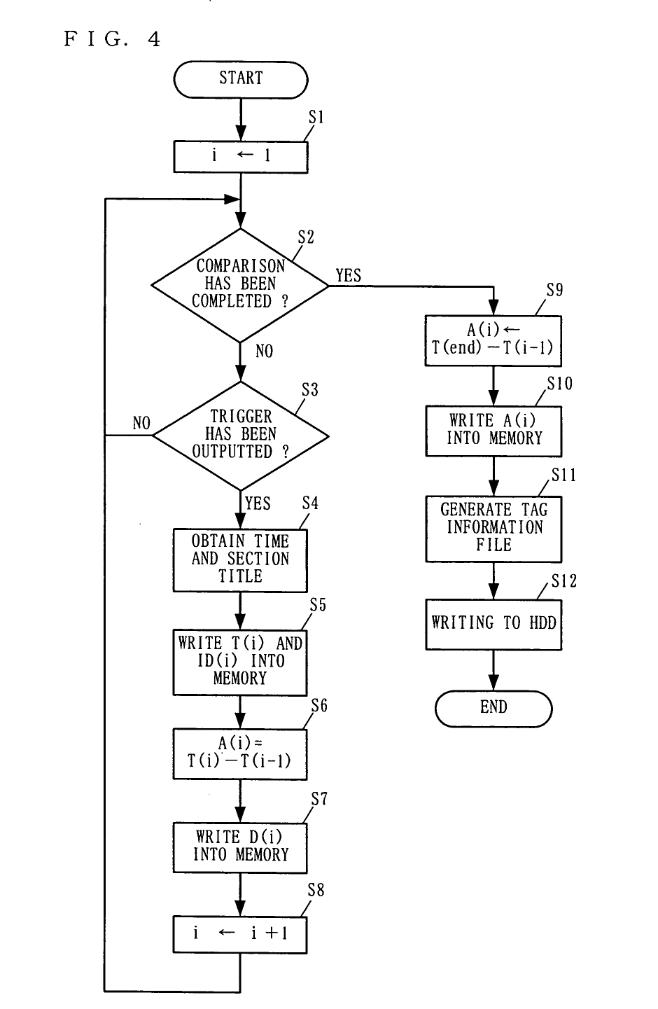

Next, tag information generation in the AV stream processing device 100 is described with reference to FIG. 3, which is a block diagram of the selector unit 111 and the comparison unit 112, and FIG. 4, which shows the procedure for generating tag information. As shown in FIG. 3, the comparison unit 112 includes, for example, an audio comparison unit 150 and a video comparison unit 160. The audio comparison unit 150 includes a feature value comparator 151, a counter 152 and a continuous value comparator 153, and the video comparison unit 160 includes a feature value comparator 161, a counter 162 and a continuous value comparator 163.

The feature value comparator 151 in the audio comparison unit 150 compares audio data outputted from the splitter unit 107 with a mute determination threshold Pa stored in the selector unit 111. If the feature value comparison unit 151 determines that the sound volume is less than or equal to the threshold Pa, the counter 152 counts time until the sound volume becomes greater than Pa. The continuous value comparator 153 compares the counted value in the counter 152 with the audio matching continuous value Qa. When the continuous value comparator 153 determines that the counted value in the counter 152 matches with the audio matching continuous value Qa, the continuous value comparator 153 outputs a trigger signal (step S3 in FIG. 4).

Similarly, the feature value comparator 161 in the video comparison unit 160 compares video data outputted from the splitter unit 107 with a black screen determination threshold Pb stored in the selector unit 111. Here, the black screen determination threshold Pb is, for example, the sum of brightness values per field of video data. The feature value comparator 161 obtains the sum S of brightness values per field of the video data outputted from the splitter unit 107, and compares the sum S with the black screen determination threshold Pb stored in the selector unit 111. When the feature value comparator 161 determines that the sum S is less than or equal to the black screen determination threshold Pb, the counter 162 counts time until the sum S becomes greater than the black screen determination threshold Pb. The counted value in the counter 162 is compared with a matching continuous value Qb by the continuous value comparator 163. If the continuous value comparator 163 determines that the counted value in the counter 162 matches with the matching continuous value Qb, the continuous value comparator 163 outputs a trigger signal (step S3 in FIG. 4).

The trigger signals outputted from the continuous value comparators 153 and 163 are both inputted to the host CPU 114 as an interrupt signal. The tag information generation unit 113 includes a timer for measuring elapsed time since the start of AV data. The host CPU 114 having received a trigger signal outputs a read instruction signal to read time from the timer in the tag information generation unit 113 as well as read a title from the selector unit 111 (step S4).

The time read from the timer in the tag information generation unit 113 and the title read from the selector unit 111 are written to a segment table in the memory 116 as a section start time T(i) and a section title ID(i), respectively (step S5). Specifically, each portion obtained by dividing AV data at a position where feature data has been detected corresponds to a section. Number i is a section number, which is assigned in increasing order of elapsed time since the head of the AV data, such as 0, 1, 2 . . . .

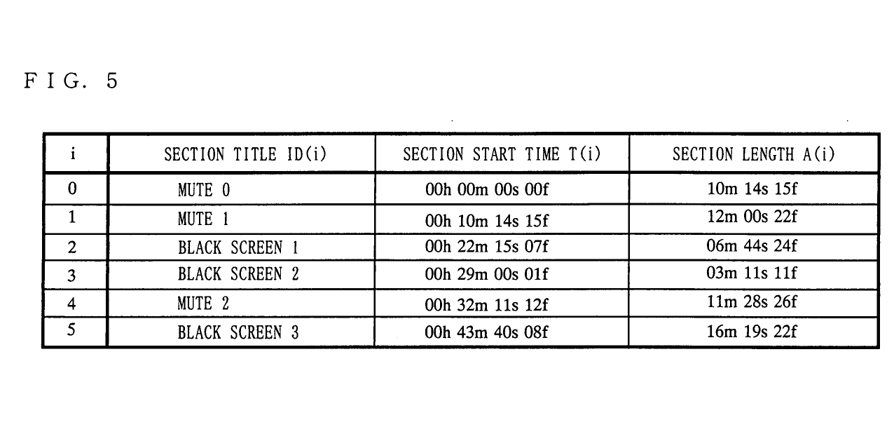

The difference between the section start time T(i) stored in the memory 116 and a section start time T(i−1) is calculated (step S6), and the result is written to the segment table in the memory 116 as a section length A(i−1) (step S7). FIG. 5 illustrates an example of the generated segment table. The start point of section number 0 is the head portion of the AV data, and therefore a section title ID(0) and a section start time T(0) may be previously stored in the field of section number 0 in the segment table.

Upon completion of writing the section title ID(i), the section start time T(i) and the section length A(i−1) to the segment table, the value of the section number i is incremented by 1 (step S8). Then, if the comparison unit 112 has not yet completed comparisons (NO in step S2), time until a trigger signal is outputted is measured. Alternatively, if all the comparisons in the comparison unit 112 have been completed, a period of time T(end)-T(i−1) since time T(i−1) at which the last trigger was outputted until an end time T(end) of the AV data is calculated and written to a segment file as the section length A(i−1) (steps S9 and S10). Thus, the writing to the segment table is completed.

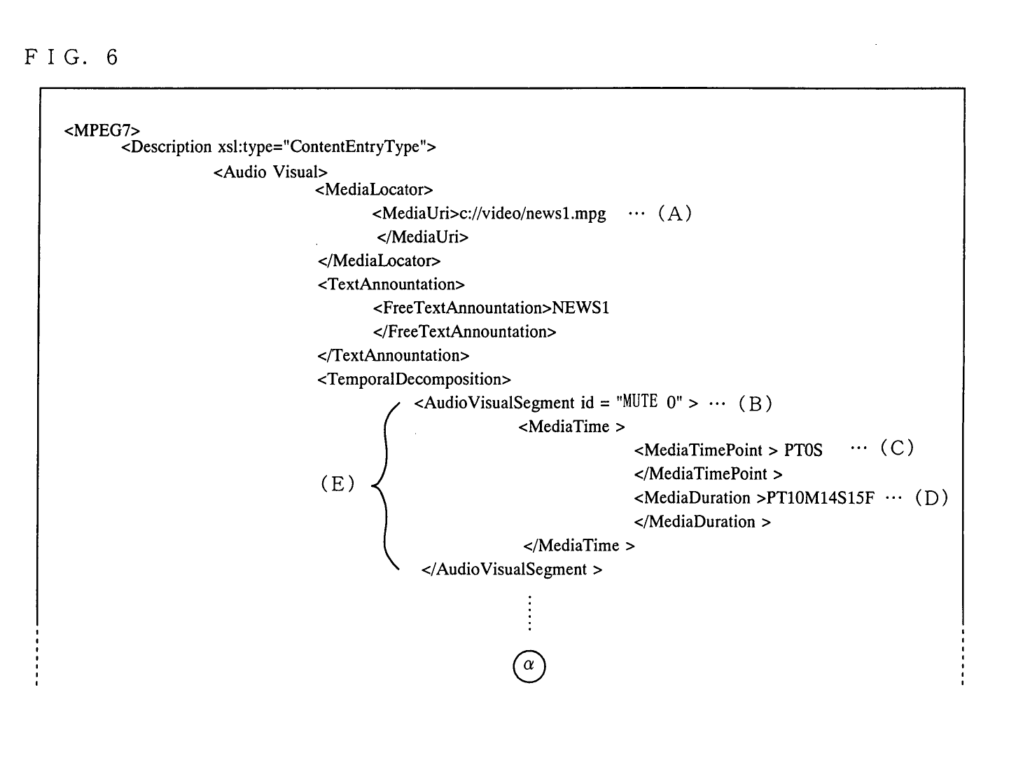

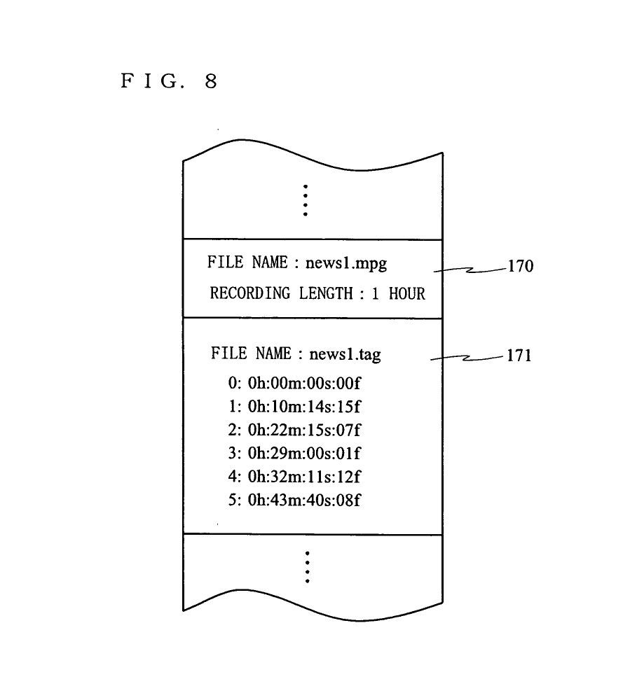

Upon completion of the writing to the segment table, data stored in the segment table is used to generate a tag information file as shown in, for example, FIG. 6 (step S11). The tag information file is generated by the host CPU 114 executing a tag information file generation program previously stored in, for example, the memory 116. The generated tag information file is added to video/audio data and written to the HDD 115 (step S12). Specifically, AV data 170 and information data 171 thereof are stored in the HDD 115 as shown in FIG. 8.

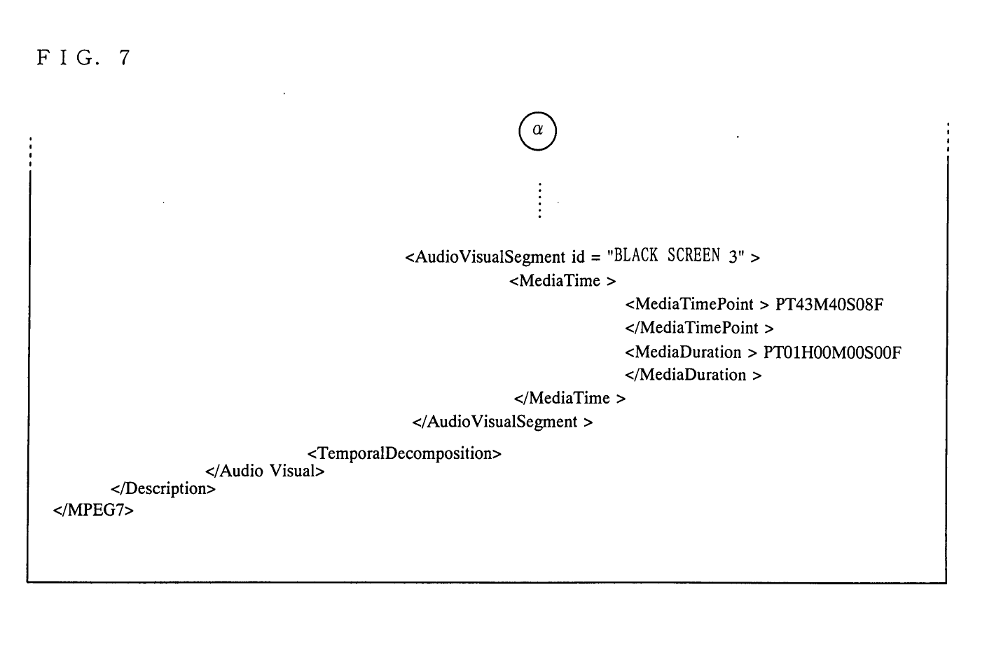

Incidentally, the information file shown in FIG. 6 and FIG. 7 is generated in MPEG7 format, which is a search description scheme described in XML. In the tag information file shown in FIG. 6, portion (A) shows a directory in the HDD 115. This directory is a directory of recorded AV data in the HDD 115. Also, portion (B) shows the section title ID(i), portion (C) shows the section start time T(i), and portion (D) shows the section length A(i). Portion (E) including the above portions (B) to (D) is generated for each section.

As described above, the AV stream processing device 100 detects from the AV data a position where feature data is contained, and generates a tag information file containing information concerning that portion. The generated tag information file can be used at the time of playing back the AV data stored in the HDD 115.

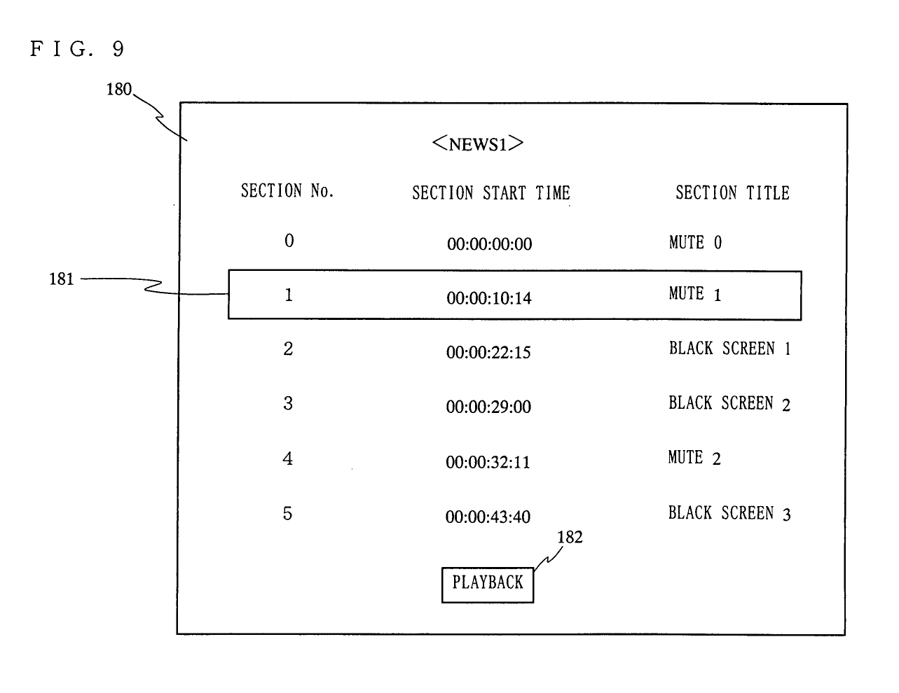

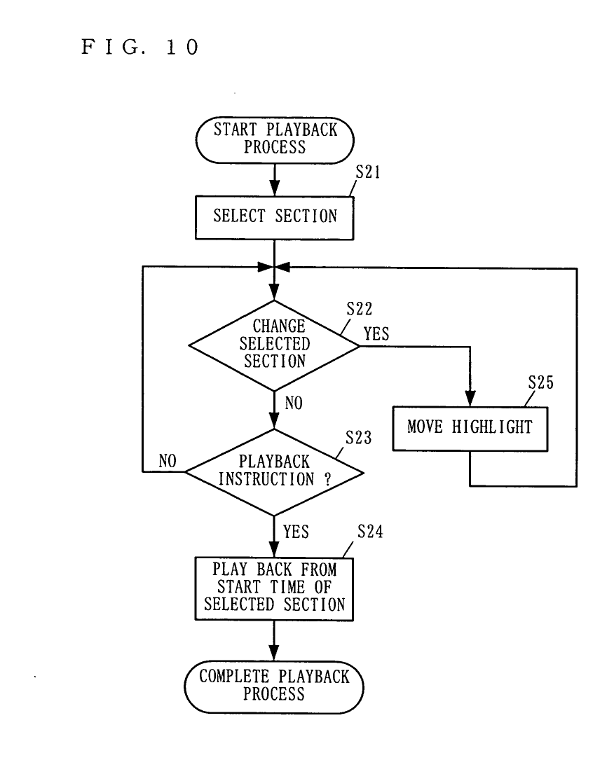

Next, playback of AV data stored in the HDD 115 is described with reference to FIG. 9 and FIG. 10. FIG. 9 is an exemplary screen for allowing the user to select a playback position, which is generated by the graphic generation unit 118 shown in FIG. 1 using a tag information file stored in the HDD 115. This screen 180 displays the title of AV data, section numbers, section start times and section titles. Such screen 180 is displayed on the display unit when the user presses a section screen display button provided on the user panel 120.

The user uses the user panel 120 to select a section which he/she desires to play back now from among the sections displayed on the display unit (step S21 in FIG. 10). As shown in FIG. 9, the currently selected section is highlighted 181, so as to be distinguishable from other sections. Also, the section that is to be selected can be changed with navigation keys or the like on the user panel 120 (steps S22 and S25) until a playback button 182 is pressed so that the host CPU 114 outputs a playback instruction (step S23).

When the playback button 182 on the screen 180 is pressed, a signal indicating a selected section is inputted to the host CPU 114. The host CPU 114 instructs the HDD 115 to output data corresponding to the selected section, and the HDD 115 outputs the designated data to the MPEG decoder 117. The MPEG decoder 117 outputs the inputted data to a monitor or the like after performing a decoding process thereon.

The “mute” state used for detecting a section start position in the foregoing description is likely to take place at the time of a scene change. For example, before each topic of a news program starts, there is a mute section of a predetermined period of time or more. Accordingly, as described in the present embodiment, by setting a position where the mute state has taken place as a section start position, a new topic is always taken up at the head portion of each section. Therefore, by generating a tag information file with the AV stream processing device 100 and checking the beginning of each section, it is possible to relatively easily find a topic that is desired to be viewed.

In the case of a conventional AV stream processing device, if AV data of recorded content does not have detailed contents information, it is not possible to generate an information screen indicating the details of the content. However, in the case of the AV stream processing device 100 according to the present embodiment, it is possible to independently generate an information file even for video/audio data having no detailed contents information or EPG information, e.g., video/audio data recorded on a VHS videotape. Further, this information file can be used to generate a screen for selecting a playback position and present candidates for playback positions (section start positions) to the user, so that the user is able to know a suitable viewing start position without repeating rewinding and fast-forwarding operations, etc.

Also, in the case of the AV stream processing device 100 according to the present embodiment, the user can individually set feature data used for deciding a section start position, and therefore it is possible to improve search efficiency of each user.

In addition, the AV stream processing device 100 includes the format conversion unit 104, and therefore can convert any AV data that is desired to be recorded, regardless of format or type, to a suitable format that can be processed in the comparison unit 112. Thus, it is possible to generate an information file from AV data in any format.

In the above-described embodiment, one audio feature value and one video feature value are used to decide a section start position. However, only either the audio feature value or the video feature value may be used, or a plurality of audio feature values or a plurality of video feature values may be used.

For example, an audio comparison device and a video comparison device may be used as the audio comparison unit 150 and the video comparison unit 160, respectively, in FIG. 3 to output a trigger signal when audio data or video data matching audio data or video data previously registered in the selector unit 111 has been detected. As such, the configuration of devices included in the comparison unit 112 is not limited to the configuration shown in FIG. 2. Data used for dividing AV data into sections is not limited to audio data or video data, and may be text data, for example.

The HDD 115 in the present embodiment may be a storage unit such as a DVD-RW or the like. In addition, in the case where the audio comparison unit 150 and the video comparison unit 160 are different in processing speed, an audio timer for measuring the time when a trigger signal is outputted from the audio comparison unit 150 and a video timer for measuring the time when a trigger signal is outputted from the video comparison unit 160 may be separately provided in the tag information generation unit 113.

In the foregoing description, the time when a trigger signal is outputted from the comparison unit 112 is set as a section start time, but depending on the nature of feature value data, a time preceding by a predetermined period of time the time when a trigger signal is outputted from the comparison unit 112 may be set as a section start time. This makes it possible to prevent a malfunction where the beginning of AV data which the user desires to view is not played back when the AV data is played back from the head of a section.

In FIG. 1 and FIG. 2, title data for each feature value stored in the AV feature value holding unit 110, etc., is also stored, but such identifier data is not always required. However, by adding identifier data to each feature value data, it is made easy to distinguish which feature value is used when a plurality of AV feature values are used to detect different characteristic portions. Note that the identifier data is not limited to a text file, and may be video data in JPEG format or the like. In addition, a file name, etc., of the identifier data, which is video data, may be written to an information file, so that video can be displayed on a screen used for searching as shown in FIG. 9.

### Second Embodiment

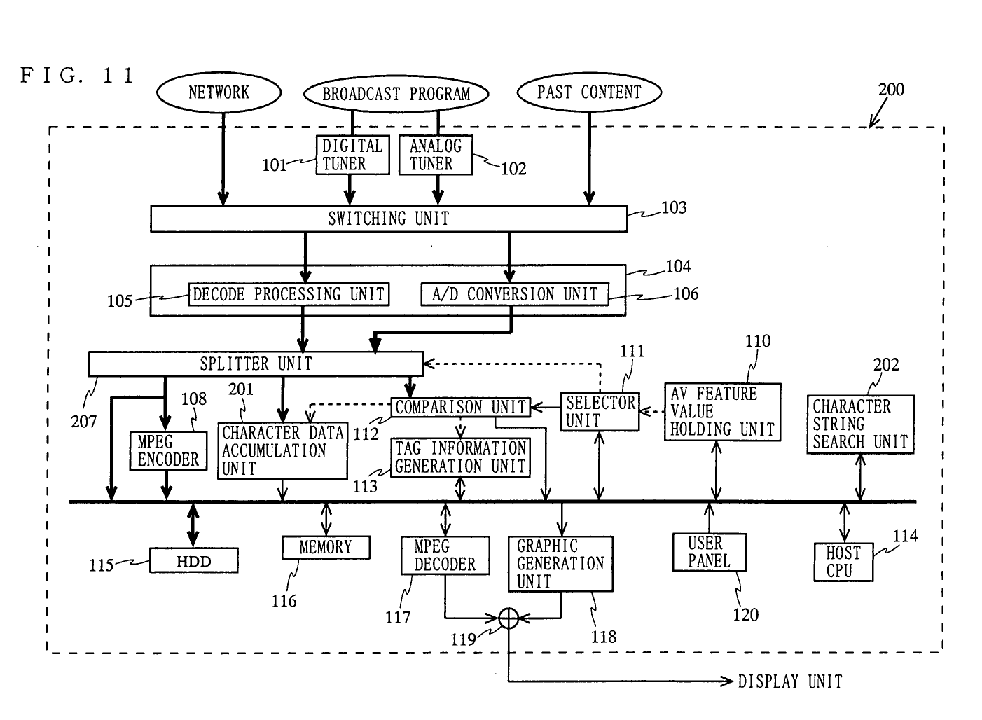

FIG. 11 is a block diagram illustrating the configuration of an AV stream processing device 200 according to a second embodiment of the present invention. In some cases, a text broadcast by airwaves and a DVD are accompanied by subtitles information or character information in addition to video information and audio information. The AV stream processing device 200 uses character information accompanying AV data to generate a keyword search file, which can be used for a keyword search. As unique features for realizing this, the AV stream processing device 200 includes a character data accumulation unit 201 and a character string detection unit 202. In addition, a splitter unit 207 includes a recording output port for outputting all inputted AV data, an output port for outputting specific data to a comparison unit 112, and an output port for outputting character data to the character data accumulation unit 201.

The same components of the AV stream processing device 200 according to the present embodiment as those described in the first embodiment and shown in FIG. 1 are denoted by the same reference numerals and the description thereof will be omitted. In addition, the description of the same processes performed by the AV stream processing device 200 according to the present embodiment as those described in the first embodiment will be omitted.

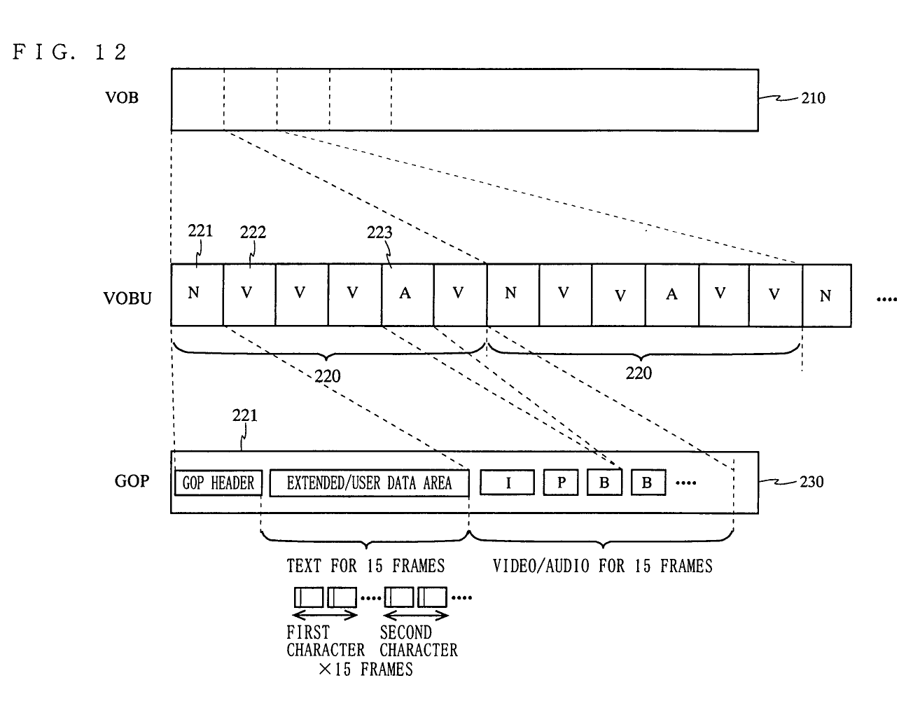

FIG. 12 is a diagram for explaining AV data based on DVD VR format. A VOB (Video Object) 210 shown in FIG. 12 is a unit of recording for video data and audio data. A VOBU (Video Object Unit) 220 is a constituent unit of the VOB 210, and includes video and audio data corresponding to 0.4 to 1 second. The VOBU 220 is composed of a navigation pack 221 containing character information, a video pack 222 containing video information, and an audio pack 223 containing audio data. The navigation pack 221, the video pack 222 and the audio pack 223 are indicated by “N”, “V” and “A”, respectively, in the diagram. In addition, a single VOBU 220 is composed of one or two GOPs (Groups of Pictures) 230.

The navigation pack 221 is composed of a “GOP header” and an “extended/user data area”. The audio pack 223 and the video pack 222 are composed of I pictures (Intra-coded pictures), P pictures (Predictive coded pictures) and B pictures (Bi-directionally coded pictures), which represent video/audio information for fifteen frames.

The “extended/user data area” of the navigation pack 221 contains character data for two characters per frame, i.e., character data for thirty characters in total. The character data is outputted from the splitter unit 207 to the character data accumulation unit 201.

While the foregoing has been described by taking an example of the DVD, in the case where AV data that is to be recorded is data of an analog broadcast program, information corresponding to twenty-one lines in the first and second fields may be outputted from the splitter unit 207 to the character data accumulation unit 201. That is, the character data accumulation unit 201 receives only character data contained in the AV data that is to be recorded.

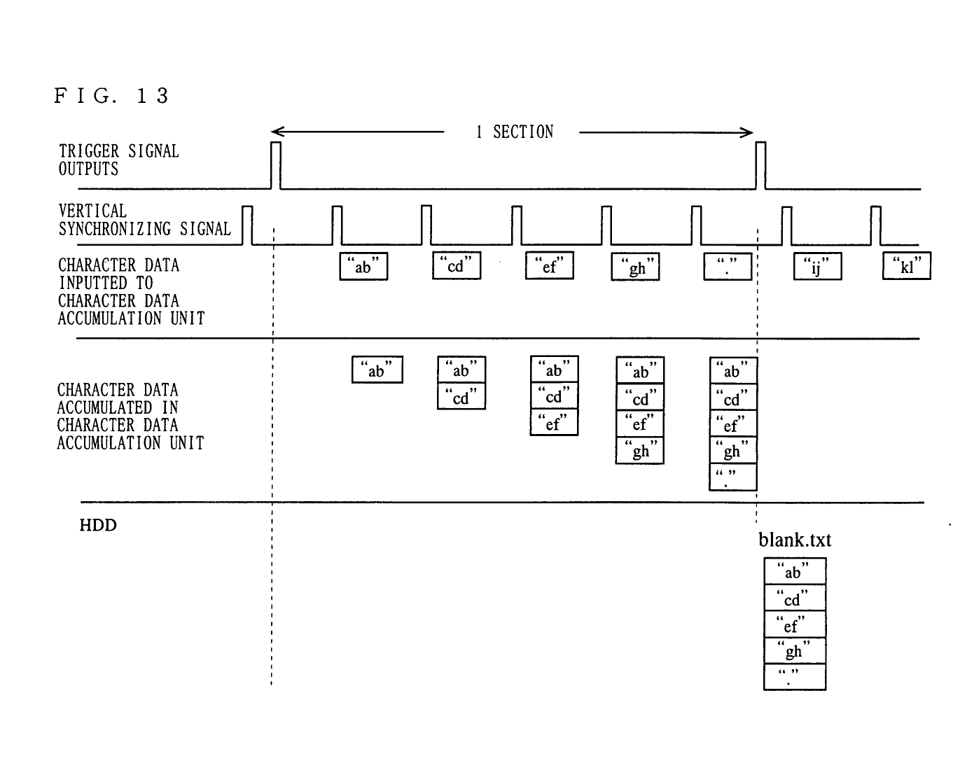

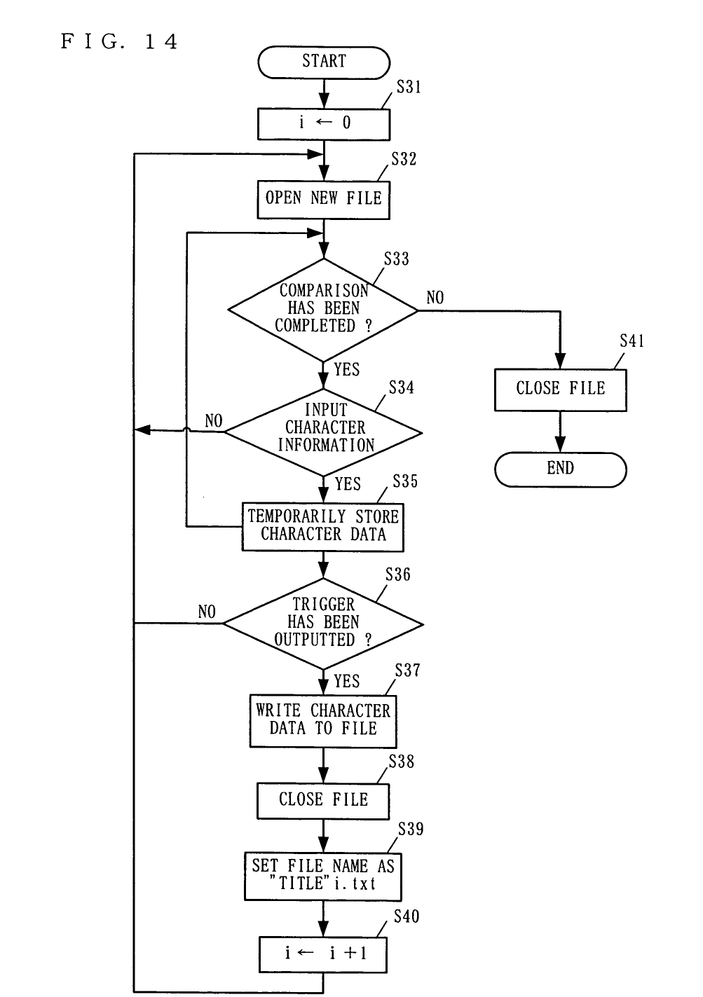

Hereinbelow, the procedure for generating a search file for AV data that is to be recorded to the HDD 115 is described with reference to FIG. 13 and FIG. 14. The top row in FIG. 13 shows times to output a trigger signal from the comparison unit 112. The second row from the top shows times to output a vertical synchronizing signal. The third row from the top shows times to input characters to the character data accumulation unit 201 and the characters that are to be inputted. The fourth row from the top shows characters temporarily accumulated in the character data accumulation unit 201. The bottom row in FIG. 13 shows a character string described in a keyword search file generated based on character data temporarily accumulated in the character data accumulation unit 201.

FIG. 14 is a flow chart illustrating the procedure for generating a keyword search file. First, when recording to the HDD 115 is started, a new text file is opened (step S32 in FIG. 14). If character data has been detected from AV data that is to be recorded, the splitter unit 207 outputs it to the character data accumulation unit 201.

The character data accumulation unit 201 temporarily accumulates the inputted character data until a trigger signal is outputted from the comparison unit 112 (steps S34 to S36). In FIG. 13, character data pieces accumulated in the character data accumulation unit 201 in a period until the trigger signal is outputted are “ab”, “cd”, “ef”, “gh” and “.” in this order. Character data pieces “ij” and “kl”, which are inputted to the character data accumulation unit 201 after the trigger signal is outputted, are temporarily accumulated in the character data accumulation unit 201, separate from the character data pieces “ab”, “cd”, “ef”, “gh” and “.”, which are inputted to the character data accumulation unit 201 before the trigger signal has been outputted.

When the trigger signal is outputted from the comparison unit 112, the character data pieces “ab”, “cd”, “ef”, “gh” and “.” temporarily accumulated in the character data accumulation unit 201 are written to the file that has been opened in step S32 (step S37). Thereafter, this text file is closed (step S38), and it is assigned a file name associated with a section title ID(i), such as mute0.txt, and stored to the HDD 115 as a keyword search file (step S39). Upon completion of this process, section number i is incremented by 1 (step S40). As such, the process of generating a keyword search file is carried out until completion of comparison in the comparison unit 112 (steps S33 and S41).

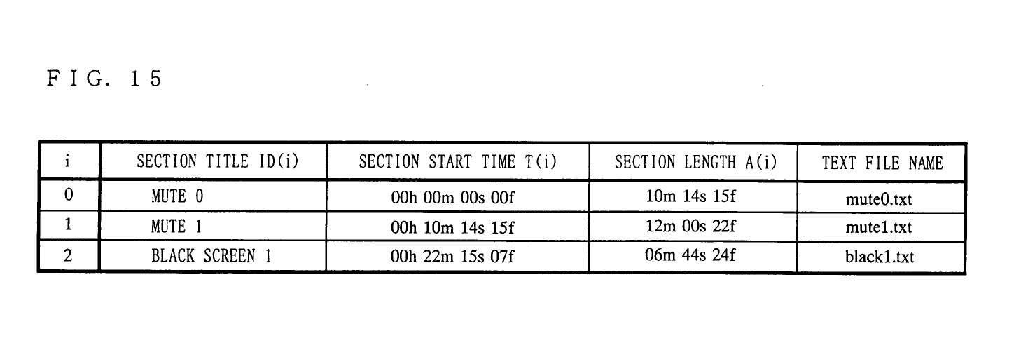

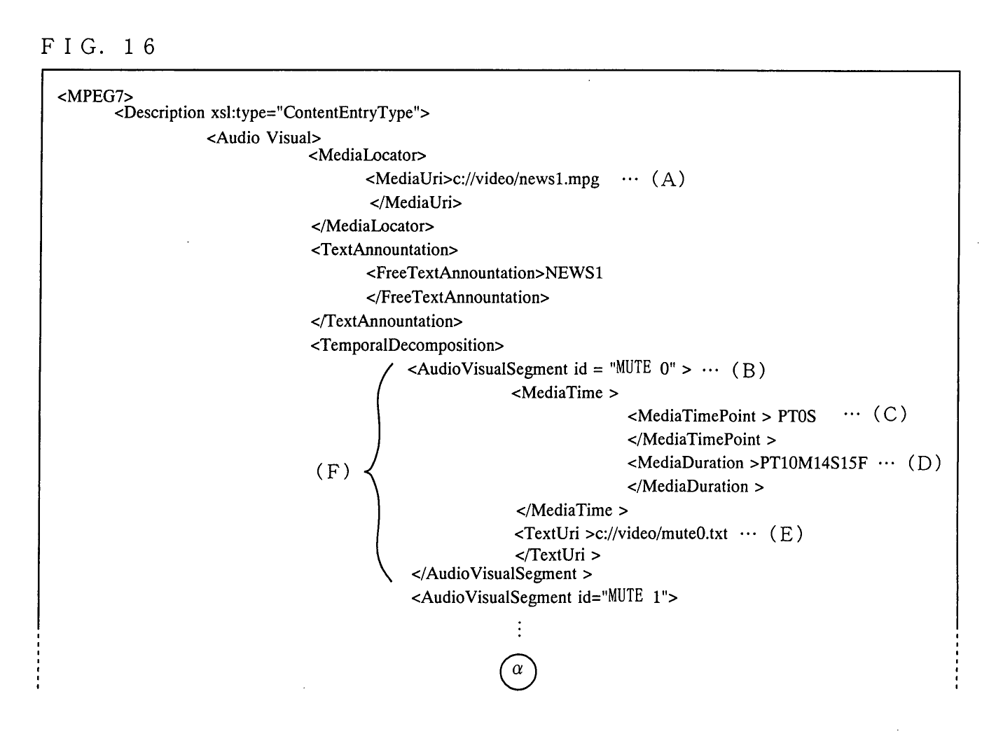

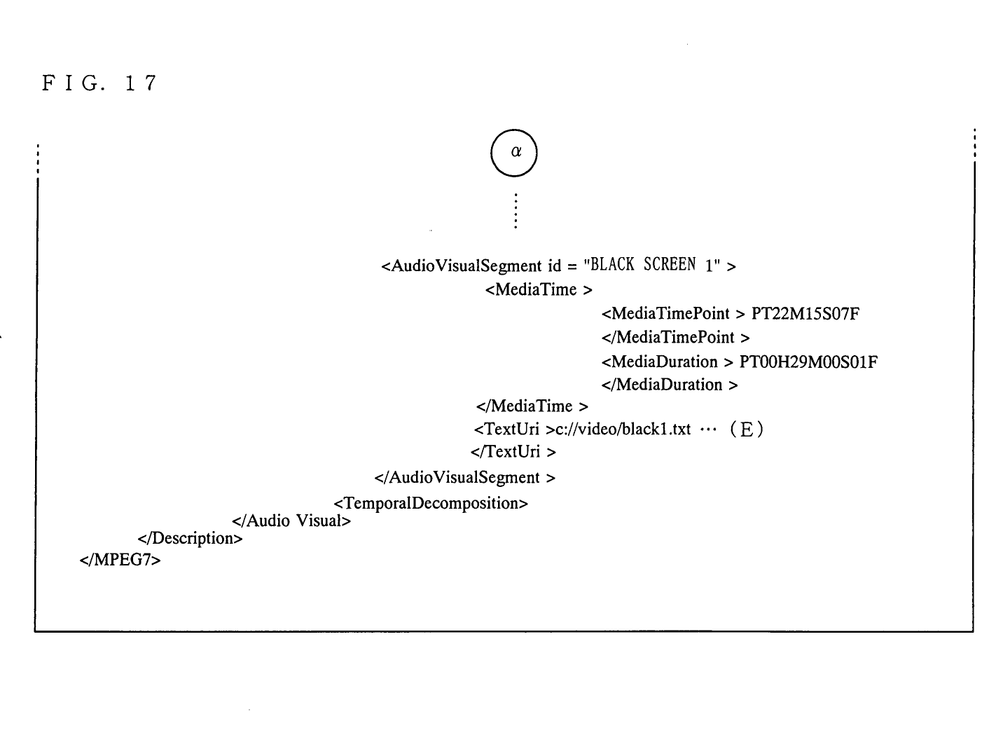

The name of each keyword search file and so on are also recorded to a segment table in the memory 116 as shown in FIG. 15. FIG. 16 and FIG. 17 are diagrams showing an example of a tag information file generated by using the segment table. FIG. 16 and FIG. 17 are generated in MPEG7 format, which is a search description scheme described in XML. In the tag information file shown in FIG. 16, portion (A) shows a directory in the HDD 115. This directory is a directory of recorded AV data in the HDD 115. Also, portion (B) shows a section title ID(i), portion (C) shows a section start time T(i), and portion (D) shows a section length A(i). In addition, portion (E) shows a directory in the HDD 115 where a keyword search file for this section is stored. Portion (F) including the above portions (B) through (E) is generated for each section.

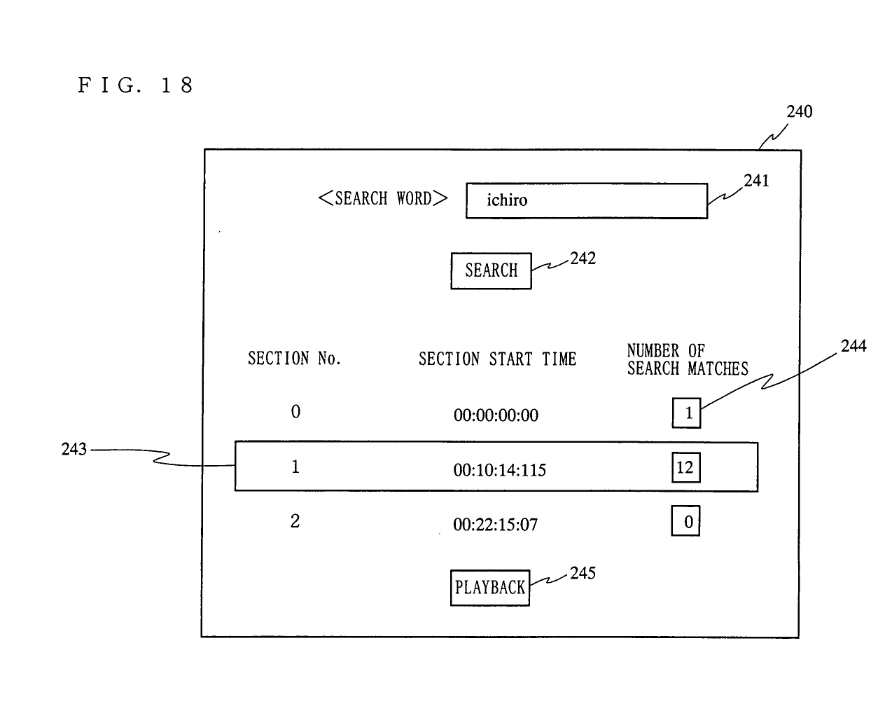

Next, a method for searching through the details of recorded content by using a generated keyword search file is described with reference to FIG. 18 through FIG. 20. FIG. 18 illustrates an example of a screen (keyword entry prompt) 240 that is to be displayed on a display unit such as a monitor. The screen 240 is a screen for displaying section information for AV data recorded in the HDD 115 and keyword search results. Provided in an upper portion of the screen 240 are a search keyword entry box 241 for entering characters that are desired to be searched for and a search button 242. In addition, below the search button 242, there are displayed section numbers and section start times, and further, there are provided section information fields indicating search match number indicators 244 for displaying a search result for each section and a playback button 245. Such screen 240 is generated in the following procedure.

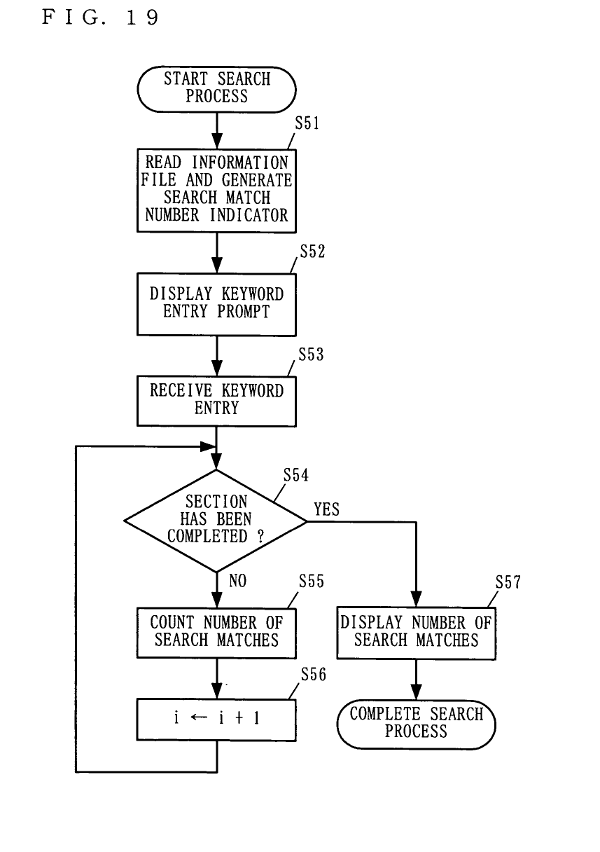

First, when a search screen display button on the user panel 120 is pressed, a tag information file stored in the HDD 115 is read to generate an area for the search match number indicators 244 (step S51 in FIG. 19). Then, the screen 240 as shown in FIG. 18 is displayed on the monitor (step S52). Note that at this time, nothing is displayed on the search match number indicators 244 and the search keyword entry box 241.

When the screen is displayed, the user enters a search keyword in the search keyword entry box 241. In FIG. 18, the word “ichiro” is entered as a search keyword. In this state, if the search button 242 is pressed, the word “ichiro” is searched for from within the keyword search file.

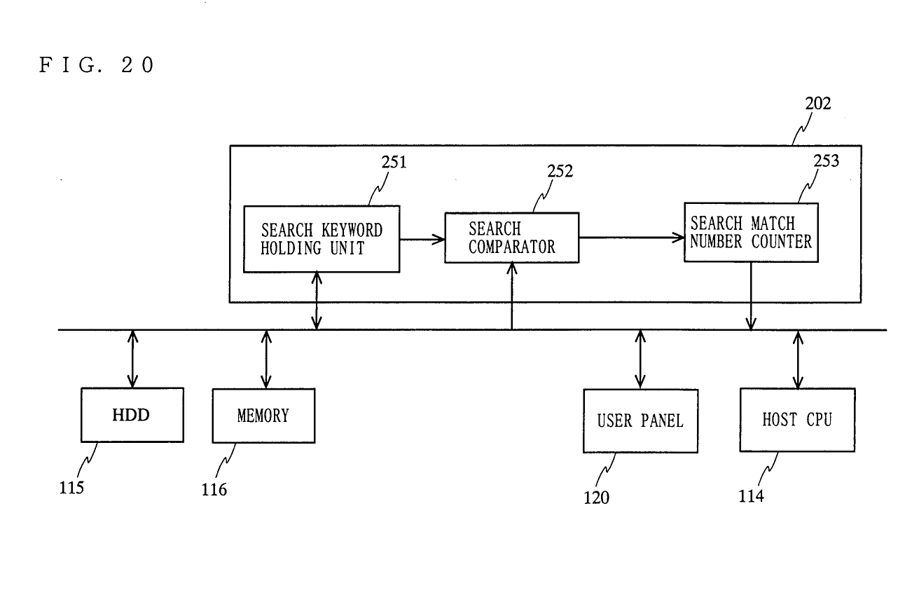

FIG. 20 mainly illustrates features used for searching among the components of the AV stream processing device 200 shown in FIG. 11. The character string detection unit 202 includes a search keyword holding unit 251, a search comparator 252 and a search match number counter 253. When a keyword is inputted from the user panel 120, the keyword is stored to the search keyword holding unit 251 in the character string detection unit 202. In this state, if the search button 242 on the screen 240 is pressed, the host CPU 114 having received a signal outputs an instruction signal to read a keyword search file from the HDD 115.

Character data pieces described in the keyword search file read from the HDD 115 are sequentially inputted to the search comparator 252 from the head of a data string. The search comparator 252 compares the character string “ichiro” stored in the search keyword holding unit 251 with a character string described in the search keyword holding unit 251, and if they match, outputs a signal to the search match number counter 253.

The search match number counter 253 increments the counter value by 1 upon each input of a signal, thereby counting the number of matches in the keyword search file (step S55 in FIG. 19). Upon completion of one keyword search file, the host CPU 114 reads a value from the search match number counter 253, and the read value is written into the memory 116. Search is performed on keyword search files for all sections. Upon completion of the search, numeral values stored in the memory 116 are read and displayed in the search match number indicators 244 of the screen 240 (step S57).

The screen 240 shown in FIG. 18 indicates the case where the numbers of search matches for the zeroth, first and second sections are 1, 12 and 0, respectively. The user is able to select a section to play back by viewing the search results. For example, if the user selects the first section having the largest number of search matches as shown in FIG. 18 and presses the playback button 245, a portion of AV data that corresponds to the first section is read from the HDD 115 into the MPEG decoder 117, so that playback starts from the head of the first section.

The AV stream processing device 200 according to the present embodiment uses character data contained in content that is to be recorded to generate a keyword search file for each section defined by the tag information generation unit 113. In addition, the generated keyword search file can be used for a keyword search. Therefore, by using the AV stream processing device 200, it is possible to further improve efficiency of search by the user.

In order to generate a keyword search file, the character data accumulation unit 201 of the present embodiment has a function as an arithmetic processing unit and a function as a memory. However, instead of providing the character data accumulation unit 201, the host CPU 114 and the memory 116 may be configured to perform processes that are to be performed by the character data accumulation unit 201.

### Third Embodiment

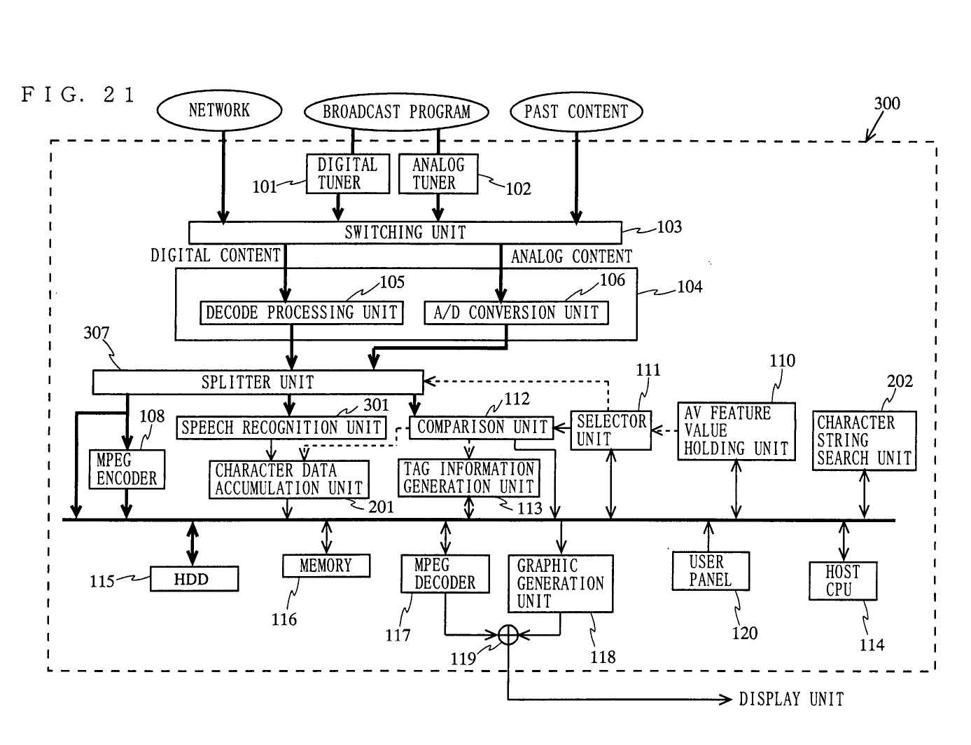

FIG. 21 is a block diagram illustrating the configuration of an AV stream processing device 300 according to a third embodiment of the present invention. The AV stream processing device 300 of the present embodiment is characterized by generating character data used for searching from audio data. As unique features for realizing this, the AV stream processing device 300 includes a speech recognition unit 301, a character data accumulation unit 201 and a character string search unit 202.

A splitter unit 307 has a recording output port for outputting all inputted AV data, an output port for outputting specific data to a comparison unit 112, and an output port for outputting audio data to the speech recognition unit 301.

The same components of the AV stream processing device 300 as those described in the first and second embodiments and shown in FIG. 1 and FIG. 11 are denoted by the same reference numerals, and the description thereof will be omitted. Also, the description of the same processes of the AV stream processing device 300 according to the present embodiment as those described in the first and second embodiment will be omitted.

The speech recognition unit 301 performs speech recognition on audio data outputted from the splitter unit 107 to convert data of a human conversation portion into text data, and outputs it to the character data accumulation unit 201. The character data accumulation unit 201 accumulates therein data for one section, i.e., data outputted from the splitter unit 107 since a trigger signal is outputted from the comparison unit 112 until the next trigger signal is outputted.

The AV stream processing device 300 of the present embodiment generates a keyword search file for each section based on the text data obtained from the audio data. The generated keyword search file can be used for a keyword search.

In the case where the audio data is 5.1 ch audio data, for example, the splitter unit 307 may extract only audio data contained in the center channel, and output it to the speech recognition unit 301. As such, by extracting audio data on a specific channel that is highly likely to be usable for searching, it is made possible to improve the data processing speed and accuracy in the speech recognition unit 301.

### Fourth Embodiment

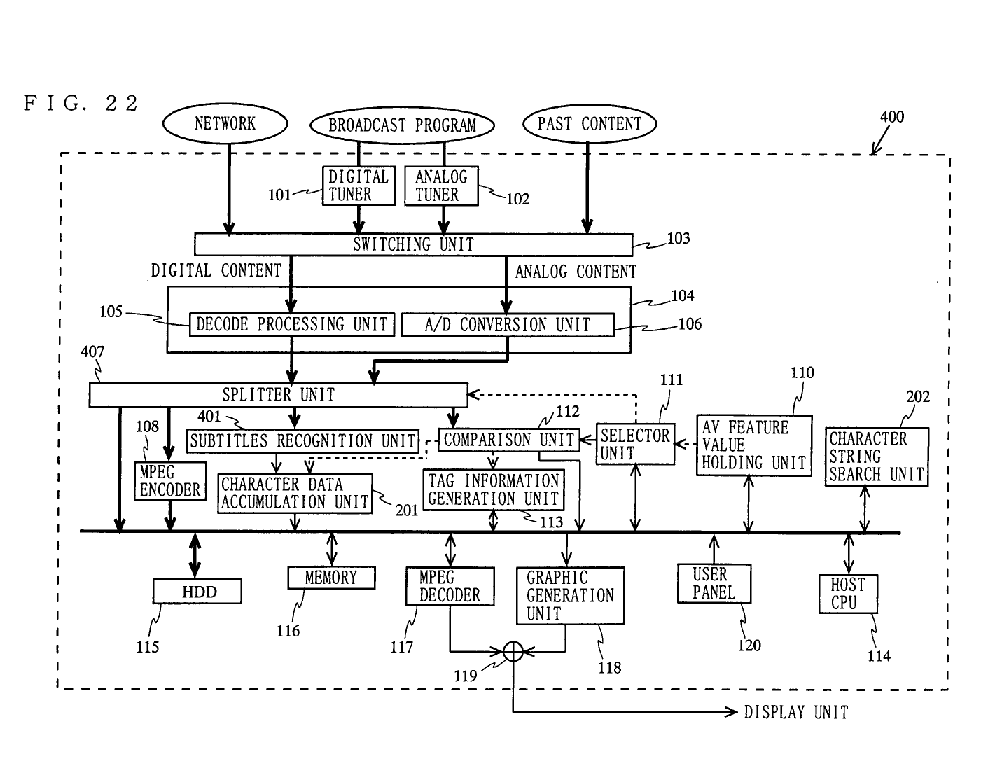

FIG. 22 is a block diagram illustrating the configuration of an AV stream processing device 400 according to a fourth embodiment of the present invention. The AV stream processing device 400 according to the present embodiment is characterized by generating text data used for searching from video data containing subtitles. As unique features for realizing this, the AV stream processing device 400 includes a subtitles recognition unit 401, a character data accumulation unit 201 and a character string search unit 202.

A splitter unit 407 has a recording output port for outputting all inputted AV data, an output port for outputting specific data to a comparison unit 112, and an output port for outputting video data to the subtitles recognition unit 401. The same components of the AV stream processing device 400 as those described in the first and second embodiments and shown in FIG. 1 and FIG. 11 are denoted by the same reference numerals and the description thereof will be omitted. Also, the description of the same processes performed by AV stream processing device 400 according to the present embodiment as those described in the first and second embodiments will be omitted.

In the present embodiment, the splitter unit 407 outputs only video data containing subtitles to the subtitles recognition unit 401. The video data containing subtitles means video data for the bottom ¼ of the area of a frame, for example. The subtitles recognition unit 401 recognizes characters written in a subtitles portion of inputted video data, and outputs data of a string of the recognized characters to the character data accumulation unit 201.

The character data accumulation unit 201 accumulates therein character data contained in one section. The generated character data is stored to the HDD 115. In addition, as information concerning each section, an address of a keyword search file for each section and so on are described in a tag information file generated by the AV stream processing device 400.

The AV stream processing device 400 according to the present embodiment generates a keyword search file for each section based on character data obtained from subtitles in a video. The generated keyword search file can be used for a character string search.

While embodiments of the present invention have been described above, the foregoing description is, in all aspects, merely an illustration of the present invention, and is not intended to limit the scope of the present invention. Thus, it is understood that various improvements and variations can be made without departing from the scope of the present invention.

### INDUSTRIAL APPLICABILITY

A video/audio stream processing device according to the present invention is useful as a device for storing and viewing AV data and so on. In addition, it is applicable to uses such as AV data edit/playback devices and AV data servers.

1. A video/audio stream processing device for storing video/audio data after adding thereto information concerning the video/audio data, comprising:
a feature data holding unit for storing feature data concerning video/audio or characters;
a feature data detection unit for detecting a position where the feature data is contained in the video/audio data;
a tag information generation unit for generating tag information when the feature data is detected in the feature data detection unit; and
a video/audio data storage unit for storing the video/audio data and the tag information.

2. The video/audio stream processing device according to claim 1, further comprising a timer for measuring time at the detected position on the video/audio data, wherein
the tag information contains time information based on the time measured by the timer.

3. The video/audio stream processing device according to claim 1, further comprising a specific data extraction unit for extracting specific data, which is used for detection in the feature data detection unit, from a plurality of types of data included in the video/audio data, and outputting the specific data to the feature data detection unit.

4. The video/audio stream processing device according to claim 3, further comprising a data format conversion unit for converting the video/audio data into digital data in a predetermined format, and outputting the digital data to the specific data extraction unit, wherein
the data format conversion unit includes:
an analog data conversion unit for converting analog data into digital data in a predetermined format; and
a digital data conversion unit for converting digital data in a format other than the predetermined format into digital data in the predetermined format.

5. The video/audio stream processing device according to claim 1, wherein the tag information contains identifier data indicating which feature data has been used for detection.

6. The video/audio stream processing device according to claim 1, further comprising a graphic generation unit for generating a screen which allows a user to select a playback position by using the tag information, and displays the detected position as a candidate for the playback position.

7. The video/audio stream processing device according to claim 1, further comprising a keyword search information generation unit for generating keyword search information by using character data obtained from the video/audio data.

8. The video/audio stream processing device according to claim 7, further comprising:
a video data extraction unit for extracting video data in a specific region of the video/audio data where subtitles are contained; and
a subtitles recognition unit for converting into character data subtitles contained in the video data extracted by the video data extraction unit, wherein
the keyword search information generation unit uses the character data obtained by the video recognition unit to generate the keyword search information.

9. The video/audio stream processing device according to claim 7, further comprising:
an audio data extraction unit for extracting audio data from the video/audio data; and
a speech recognition unit for converting the audio data extracted by the audio data extraction unit into character data, wherein
the keyword search information generation unit uses the character data obtained by the speech recognition unit to generate the keyword search information.

10. The video/audio stream processing device according to claim 7, further comprising:
a keyword input unit for inputting characters which are desired to be searched for; and
a keyword search unit for searching the keyword search information for the characters inputted from the keyword input unit.

11. A video/audio stream processing method for storing video/audio data after adding thereto information concerning the video/audio data, comprising:
storing the video/audio data and detecting a position where predetermined feature data concerning video/audio or characters is contained in the video/audio data;
generating tag information when the detecting has been performed; and
storing the video/audio data after adding the tag information thereto.

12. The video/audio stream processing method according to claim 11, further comprising measuring time at the detected position on the video/audio data, wherein
the tag information contains time information based on the specified time.

13. The video/audio stream processing method according to claim 11, further comprising, before performing the detecting, extracting data for use in the detecting from a plurality of types of data included in the video/audio data.

14. The video/audio stream processing method according to claim 13, further comprising, when the video/audio data is analog data or digital data in a format other than a predetermined format, converting the video/audio data into digital data in the predetermined format before extracting the data for use in the detecting.

15. The video/audio stream processing method according to claim 11, wherein the tag information contains identifier data indicating which feature data has been used for the detecting.

16. The video/audio stream processing method according to claim 11, further comprising generating a screen which allows a user to select a playback position by using the tag information, and displays the detected position as a candidate for the playback position.

17. The video/audio stream processing method according to claim 11, further comprising:
obtaining character data from the video/audio data; and
generating keyword search information by using the obtained character data.

18. The video/audio stream processing method according to claim 17,
wherein the character data is obtained by:
extracting video data in a specific region of the video/audio data where subtitles are contained; and
converting into character data subtitles contained in the extracted video data.

19. The video/audio stream processing method according to claim 17,
wherein the character data is obtained by:
extracting audio data from the video/audio data; and
converting the extracted audio data into character data.

20. The video/audio stream processing method according to claim 17, further comprising:
generating the keyword search information for each section defined by the detected position;
searching the keyword search information for characters inputted by a user; and
generating a screen for displaying a search result for each section.
